(19) United States
(12) Patent Application Publication
(10) Pub. No.: US 2011/0206305 A1
(43) Pub. Date: Aug. 25, 2011

(54) SINTERED BEARING

(75) Inventors: Fuyuki Ito, Mie (JP); Kazuo Okamura, Mie (JP); Makoto Kawamura, Aichi (JP); Hiroko Kawamura, Aichi (JP); Noriyoshi Kurata, Aichi (JP)

(73) Assignee: NTN CORPORATION, Osaka-shi, Osaka (JP)

(21) Appl. No.: 13/126,091

(22) PCT Filed: Sep. 29, 2009
(86) PCT No.: PCT/JP2009/066878

§ 371 Date: Apr. 26, 2011

(30) Foreign Application Priority Data
Oct. 29, 2008 (JP) 2008-278468

(51) Int. Cl. F16C 33/04

(52) U.S. Cl. 384/276

(57) ABSTRACT

With use of separated alloy powder (10) as a sintering material, it is possible to utilize characteristics of metals of different types (SUS steel and Cu, for example). Further, a boundary surface between regions constituted by different metals is at least partially alloyed. Thus, it is possible to enhance bonding strength between the regions, and possible to enhance strength of a sintered bearing.

### TECHNICAL FIELD

The present invention relates to a sintered bearing obtained by sintering metal powder after compression-molding the same.

### BACKGROUND ART

The sintered bearing is formed by sintering metal powder at a predetermined temperature after compression-molding the same. For example, a sintered bearing disclosed in Patent Document 1 is used for supporting a rotary shaft inserted along an inner periphery thereof. When the shaft is rotated, oil impregnated in inner pores of the sintered bearing oozes from surface pores, and the oil is supplied to a sliding portion with respect to the shaft. With this, lubricancy between the bearing and the shaft is enhanced.

When a metal powder obtained by mixing metal powders of different types with each other is used as a metal powder forming a sintered bearing, a bearing is obtained in which material characteristics of the metal powders are utilized. For example, the sintered bearing disclosed in Patent Document 1 mentioned above is formed by sintering a mixture metal powder containing a Cu powder and a SUS steel (stainless steel, hereinafter the same applies) powder. In this manner, inclusion of the SUS steel powder excellent in hardness allows enhancement of abrasion resistance of a surface of the bearing, in particular, a bearing surface subjected to sliding with respect to the rotary shaft, and inclusion of the relatively soft Cu powder allows enhancement of moldability of the sintered bearing.
Patent Document 1: JP 2006-214003 A
Patent Document 2: JP 2001-279349 A

### DISCLOSURE OF THE INVENTION

### Problem to be Solved by the Invention

However, when the metal powders of different types are mixed and subjected to sintering as described above, the characteristics of the metals may have adverse effects on the performance of the sintered bearing. For example, in a case where a sintered bearing is formed by sintering a mixture metal powder containing the SUS steel powder at a relatively low temperature (approximately 800° C.), oxide films are formed on surfaces of particles of the SUS steel powder, which may lead to a risk that bonding strength between the particles is weakened by an influence of the oxide films and strength of the sintered bearing becomes insufficient. Meanwhile, when the bearing is sintered at a relatively high temperature (1200° C., for example), formation of the oxide films can be suppressed. On the other hand, the sintered bearing becomes excessively hard owing to progress of sintering, and hence it becomes difficult to effect sizing of the sintered bearing, formation of dynamic pressure grooves, or the like subsequent thereto. Further, in a case where the mixture metal powder containing the Cu powder, Cu is completely molten when sintering is effected at a temperature higher than the melting point of Cu. Thus, a shape of the bearing cannot be maintained, which may lead to a risk of deterioration in dimensional accuracy of the bearing.

For example, Patent Document 2 discloses a sintered bearing formed of iron powder covered with copper. In this manner, when surfaces of particles of the iron powder is covered with copper, it is possible to prevent formation of oxide films on the surfaces of the particles of the iron powder even in a case where sintering is effected at a relatively low temperature. However, the iron powder covered with copper is formed, for example, by plating copper on the surfaces of the particles of the iron powder, and fixing strength between the iron powder and copper is not very high. Thus, the particles of the iron powder and copper are liable to be peeled off owing to an impact load, which may lead to a risk of deficiency in strength of the bearing.

It is therefore an object of the present invention to provide a sintered bearing which is made of multiple metals of different types and can be formed without involving failures such as deteriorations in workability and strength.

### Means for Solving the Problem

In order to solve the above-mentioned problem, the present invention provides a sintered bearing formed from a sintered compression-molded body of metal powder, the metal powder containing separated alloy powder which contains particles each having multiple regions constituted by different metals and in which a boundary surface between the region is at least partially alloyed.

As described above, the metal powder containing the separated alloy powder is used in the present invention, and hence it is possible to utilize characteristics of metals of multiple types, which constitute particles of the separated alloy powder. Further, in the separated alloy powder, the boundary surface between the regions constituted by different metals is at least partially alloyed, and hence it is possible to enhance bonding strength between the regions, and to enhance strength of the sintered bearing.

For example, in a case where the separated alloy powder has regions constituted by a Fe-based metal (metal containing Fe as a main component), exposure of Fe on the bearing surface allows enhancement of abrasion resistance of the bearing surface. In particular, when a SUS steel is used as the Fe-based metal, owing to Cr contained in the SUS steel, an effect of corrosion resistance can be obtained in addition to the abrasion resistance. When a surface of the Fe-based metal is at least partially covered with another metal, it is possible to reduce an area of Fe exposed on the surfaces of the particles. Thus, it is possible to suppress formation of oxide films on the surfaces of the particles, and to prevent the bonding strength between the particles from deteriorating owing to the oxide films, and consequently to prevent the strength of the sintered bearing from deteriorating. Further, suppression of the formation of the oxide films enables sintering at a relatively low temperature. As a result, hardness of the sintered bearing is not excessively increased, and hence workings such as sizing and formation of dynamic pressure grooves are facilitated.

Further, in a case where the separated alloy powder has regions constituted by a Cu-based metal (metal containing Cu as a main component), Cu is softer than the SUS steel or the like, and hence workability in compression-molding of metal powder, sizing, or the like is enhanced, and hence it is possible to enhance dimensional accuracy of the bearing. Further, exposure of relatively soft Cu on the bearing surface allows enhancement of slidability with respect to a mating member (shaft member, for example).

The separated alloy powder as described above can be produced, for example, by so-called atomizing in which various metals are mixed with each other in a molten state before being cured by cooling through atomization of molten metal thus obtained by mixing. According to atomizing, different metals can be evenly mixed with each other, and hence characteristics of the metals are more easily exerted.

The sintered bearing as described above can be used, for example, as a fluid dynamic bearing device having a bearing surface in which a dynamic pressure generating portion for generating a dynamic pressure effect in a fluid is formed.

### EFFECTS OF THE INVENTION

As described above, according to the present invention, it is possible to provide a sintered bearing which is made of multiple metals of different types and can be formed without involving failures such as deteriorations in workability and strength.

### BEST MODE FOR CARRYING OUT THE INVENTION

In the following, an embodiment of the present invention is described with reference to drawings.

FIG. 1 illustrate a bearing sleeve 1 as a sintered bearing according to the embodiment of the present invention. The bearing sleeve 1 is formed into a cylindrical shape by being opened at both ends, and is incorporated into a fluid dynamic bearing device 100 illustrated in FIGS. 4 and 5. The bearing sleeve 1 is formed by sintering metal powder containing separated alloy powder. Specifically, the bearing sleeve 1 is formed of metal powder obtained by mixing separated alloy powder in which a surface of a SUS steel is covered with a Cu-based metal, pure copper powder, graphite powder, and the like with each other.

An inner peripheral surface 1a and a lower end surface 1c of the bearing sleeve 1 function as a radial bearing surface and a thrust bearing surface, respectively. In two regions separated from each other in an axial direction of the inner peripheral surface 1a of the bearing sleeve 1, there are formed, as radial dynamic pressure generating portions, herringbone dynamic pressure grooves 1a1 and 1a2 as illustrated, for example, in FIG. 1(a). The dynamic pressure grooves 1a1 on the upper side are formed asymmetrically with each other in the axial direction with respect to a belt-like portion in a substantially central portion of a hill portion (cross-hatched region), and an axial dimension X1 of the upper region with respect to the belt-like portion is larger than an axial dimension X2 of the lower region (X1>X2). The dynamic pressure grooves 1a2 on the lower side are formed symmetrically with each other in the axial direction.

In the lower end surface 1c of the bearing sleeve 1, there are formed, as a thrust dynamic pressure generating portion, spiral dynamic pressure grooves 1c1 as illustrated, for example, in FIG. 1(b). Further, in an outer peripheral surface 1d of the bearing sleeve 1, there is formed an arbitrary number of axial grooves 1d1 over the entire axial direction. In the illustration, three axial grooves 1d1 are equiangularly formed.

FIG. 2 is a sectional view of one particle of separated alloy powder 10. The separated alloy powder 10 has a first region 11 constituted by a Fe-based metal (SUS steel in this embodiment) abundant in Fe and a second region 12 constituted by a Cu-based metal abundant in Cu. A boundary surface between the first region 11 and the second region 12 is at least partially alloyed. The first region 11 is arranged at substantially a central portion of the particle, and a surface of the first region 11 is covered with the second region 12. Thus, a particle surface of the separated alloy powder 10 is constituted substantially by Cu of the second region 12, and the SUS steel of the first region 11 is partially exposed.

FIG. 3 is an enlarged sectional view of a bearing surface A (radial bearing surface or thrust bearing surface) of the bearing sleeve 1. As illustrated therein, pure copper powder 13 and graphite powder 14 (indicated by black dots in the figure) are arranged in spaces among particles of the separated alloy powder 10. The adjacent particles of the separated alloy powder 10 are directly bonded with each other by partially melting the surfaces thereof, or bonded through an intermediation of the particles of the pure copper powder 13 among the particles of the separated alloy powder 10. On the bearing surface A, there are exposed the first region 11 and the second region 12 of the separated alloy powder 10. By forming the bearing sleeve 1 of the separated alloy powder 10 in this manner, it is possible to impart characteristics of both the SUS steel and Cu to the bearing sleeve 1. That is, as illustrated in FIG. 3, exposure of the SUS steel (first region 11) on the surface of the bearing sleeve 1, in particular, on the bearing surface A allows enhancement of abrasion resistance of the bearing surface A. Further, exposure of Cu (second region 12) on the bearing surface A allows enhancement of slidability with respect to a sliding mating member of the bearing surface A (shaft member 2 in this embodiment, refer to FIG. 5). Further, formation of the bearing sleeve 1 with use of a material containing relatively soft Cu allows enhancement of workability of the bearing sleeve 1, with the result that dimensional accuracy can be enhanced.

Next, description is made on an example of a forming method for the bearing sleeve 1.

First, the separated alloy powder 10 is formed. The separated alloy powder 10 can be produced, for example, by so-called atomizing in which metals (Fe, Cr, and Cu in this embodiment) are mixed with each other in a molten state before being cured by cooling through atomization of molten metal thus obtained by mixing. Examples of applicable atomizing include gas atomizing in which molten metal is atomized with use of gas and water atomizing in which molten metal is atomized with use of water. The separated alloy powder 10 illustrated in FIG. 2 is produced by gas atomizing, in which an outer periphery of the SUS steel (first region 11) concentrating mainly on the central portion is covered with Cu (second region 12) so as to exhibit substantially a spherical shape as a whole. Note that, any of ferritic, martensitic, and austenitic SUS steels are usable as the SUS steel, and a mixing ratio between Cr and Ni in the SUS steel is arbitrarily selected in accordance with required bearing performance.

In producing the separated alloy powder 10, adjustment of a mixing rate of metals mixed in the molten state allows arbitrary setting of a metal constituting a core, a metal covering a surface layer thereof, and the like. For example, when a mixing ratio of Cu is higher than that of Fe, as illustrated in FIG. 2, the separated alloy powder 10 is obtained in which the SUS steel (first region 11) constitutes a core and a surface thereof is covered with Cu (second region 12). In this case, when a mixing rate of principal metals (Fe and Cu in this embodiment) is excessively small, there is a risk that the metals are fused into other metals so that separated alloy powder is not produced. Thus, it is necessary to set a mixing rate of the principal metals, to an extent that the principal metals are not fused into each other.

Next, the mixture metal powder containing the above-mentioned separated alloy powder 10 is molded into a predetermined shape by compression-molding. This mixture metal powder contains, in addition to the separated alloy powder 10, the pure copper powder, the graphite powder, Sn, Fe—P mixture powder, and the like at a proper rate. Table 1 shows examples of a composition of the mixture metal powder. Further, Table 2 shows examples of an alloy composition of the separated alloy powder 10 produced by gas atomizing.

TABLE 1

| | Material A | Material B |
|---|---|---|
| Cu | 19.0% | 17.3% |
| Fe—P mixture powder | — | 40.0% |
| Separated alloy powder | 78.7% | 39.4% |
| Sn | 1.5% | 2.5% |
| C | 0.8% | 0.8% |
| Total | 100.0% | 100.0% |

TABLE 2

| | C | Si | Mn | P | S | Cu | Ni | Cr | Mo | O | Fe |
|---|---|---|---|---|---|---|---|---|---|---|---|
| Separated alloy powder A | 0.007 | 0.09 | 0.01 | — | 0.004 | 48.6 | 0.01 | 5.43 | 0.01 | 0.05 | Bal |
| Separated alloy powder B | 0.005 | 0.22 | 0.02 | — | 0.003 | 45.7 | 0.01 | 10.41 | 0.01 | 0.07 | Bal |

As described above, modes of the SUS steel and a Cu-based metal of the separated alloy powder 10 are determined based on mixing rate of the molten metals. Accordingly, for example, merely by mixing the pure copper powder, an amount of Cu in a sintered material is increased while maintaining a mode of the particle (ratio between the SUS steel and Cu in the separated alloy powder) as illustrated in FIG. 2. In this case, when dendritic electrolytic copper powder is used as the pure copper powder, particles are more easily entangled with each other at the time of molding. Thus, it is possible to further enhance bonding strength between particles, and possible to enhance rigidity of a molded product. Further, mixture of the graphite powder into the sintered material allows enhancement of a lubricating effect at the times of working and using a bearing.

By sintering a compression-molded body at a predetermined sintering temperature, it is possible to obtain a sintered body having a shape substantially the same as that of the bearing sleeve 1. It is preferred that the sintering temperature at this time be equal to or lower than a melting point of a lowest melting metal among the multiple metals constituting the separated alloy powder 10. In this embodiment, the sintering temperature is set to be equal to or lower than the melting point of Cu (800° C., for example). In this case, the surface of the separated alloy powder 10 illustrated in FIG. 2 is formed substantially of the Cu-based metal (second region 12) while the SUS steel (first region 11) is little exposed. With this, even in a case where sintering is effected at a relatively low temperature as described above, oxide films are little formed on the surfaces of the particles. Thus, it is possible to prevent the bonding strength between the metal particles from deteriorating owing to the oxide films, and possible to enhance the strength of the bearing sleeve 1.

After that, sizing is effected on the sintered body, and dynamic pressure grooves are formed in the inner peripheral surface and end surfaces. As described above, the sintered body is obtained by sintering at a relatively low temperature. Thus, hardness thereof is not excessively increased, and hence workings such as sizing are easily effected. Further, the surfaces of the particles of the separated alloy powder 10 are formed of the relatively soft Cu-based alloy (second region 12), and hence workability of the sintered body is further enhanced. With this, it is possible to subject the following to working with high accuracy: the radial bearing surface (inner peripheral surface 1a) and the thrust bearing surface (lower end surface 1c), or the dynamic pressure generating portions (dynamic pressure grooves 1a1, 1a2, and 1c1) formed in those surfaces.

The bearing sleeve 1 formed in this manner is excellent in dimensional accuracy, and hence gap widths of a radial bearing gap facing the inner peripheral surface 1a and a thrust bearing gap facing the lower end surface 1c are set with high accuracy. As a result, it is possible to realize excellent bearing performance. Further, the dynamic pressure grooves 1a1, 1a2, and 1c1 formed in the inner peripheral surface 1a and the lower end surface 1c are processed with high accuracy. Thus, a dynamic pressure effect generated in a lubricating oil in the radial bearing gap and the thrust bearing gap is enhanced, with the result that the bearing performance can be further enhanced. Further, the boundary surface between the SUS steel (first region 11) of the separated alloy powder 10 and Cu (second region 12) is at least partially alloyed. Thus, the SUS steel and Cu are prevented from being peeled off owing to an impact load, with the result that the strength of the bearing sleeve 1 can be enhanced.

Note that, in the bearing sleeve 1, by effecting rotary sizing or the like on the inner peripheral surface 1a, the Cu-based metal (second region 12) on the surface of the separated alloy powder 10 facing the inner peripheral surface 1a may be partially removed so that the SUS steel (first region 11) is positively exposed. As described above, much exposure of the SUS steel excellent in abrasion resistance on the inner peripheral surface 1a constituting the radial bearing surface leads to further enhancement of abrasion resistance of the radial bearing surface, with the result that durability of the bearing sleeve 1 can be further enhanced. Rotary sizing may be effected prior to formation of the dynamic pressure grooves after sizing of the sintered body, or may be effected after the formation of the dynamic pressure grooves.

Further, description is made hereinabove on the case of using the separated alloy powder 10 produced by gas atomizing. However, this should not be construed restrictively, and separated alloy powder produced by water atomizing may be used. According to water atomizing, as illustrated in FIG. 4, a first region 21 (Fe-based metal, for example) can be evenly dispersed in a second region 22 (Cu-based metal, for example) of separated alloy powder 20. With this, in comparison with the separated alloy powder 10 as illustrated in FIG. 2, in which the outer periphery of the first region 11 constituting a core is covered with the second region 12, the SUS steel and Cu can be more uniformly exposed on the bearing surface. Thus, it is possible to impart characteristics of both the substances (abrasion resistance and slidability) evenly over the entire of the bearing surface. Further, according to water atomizing, the substantially spherical shape like the separated alloy powder 10 according to gas atomizing is not obtained, and a concave-convex shape is likely to be formed on the outer peripheral surface as illustrated in FIG. 4. Thus, particles are more easily deformed by compression-molding or sizing, with the result that moldability of the sintered bearing can be enhanced.

In the following, description is made on an application example of the above-mentioned bearing sleeve 1.

FIG. 5 illustrates a structural example of a spindle motor for an information apparatus incorporating the fluid dynamic bearing device 100 having the above-mentioned bearing sleeve 1. The spindle motor is used for a disk drive such as an HDD and includes the fluid dynamic bearing device 100 for rotatably supporting the shaft member 2 in a non-contact manner, a disk hub 3 mounted to the shaft member 2, a bracket 6 attached to an outer periphery of the fluid dynamic bearing device 100, and a stator coil 4 and a rotor magnet 5 which are opposed to each other through an intermediation of, for example, a gap in a radial direction. The stator coil 4 is attached to an outer peripheral surface of the bracket 6 and the rotor magnet 5 is attached to an inner periphery of the disk hub 3. Multiple disks (two in illustration) D such as magnetic disks are held by the disk hub 3. When the stator coil 4 is energized, the rotor magnet 5 is relatively rotated by an electromagnetic force between the stator coil 4 and the rotor magnet 5. With this, the disk hub 3 and the shaft member 2 are rotated integrally with each other.

FIG. 6 illustrates the fluid dynamic bearing device 100. The fluid dynamic bearing device 100 is constituted by a bottomed-cylindrical housing 7 obtained by opening one side in the axial direction, the bearing sleeve 1 arranged on an inner periphery of the housing 7 and serving as a sintered bearing, the shaft member 2 inserted along the inner periphery of the housing 7, a seal portion 9 provided to the opening portion of the housing 7. Note that, for the sake of convenience in description, description is made on the assumption that, in the axial direction, an opened side of the housing 7 is an upper side and a closed side of the housing 7 is a lower side.

The shaft member 2 is made of a metal such as a stainless steel, and is provided with a shaft portion 2a and a flange portion 2b provided at a lower end of the shaft portion 2a. The entire shaft member 2 may be made of metal. Alternatively, there may be adopted a hybrid structure of metal and a resin, in which the entire flange portion 2b or a part (both end surfaces, for example) thereof is formed of a resin.

The housing 7 made of a resin material or the like is formed into a bottomed-cylindrical cup shape. In an inner bottom surface 7b1 of the housing 7, there are formed, for example, spiral dynamic pressure grooves (not shown). To an inner peripheral surface 7c of the housing 7, the outer peripheral surface 1d of the above-mentioned bearing sleeve 1 is fixed by an appropriate means such as boding or press-fitting. Note that, the housing 7 may be integrally formed, or may be constituted by a cylindrical side portion and a lid portion closing an opening portion on one side of the side portion.

The seal portion 9 made of a resin material or the like is annularly formed. An inner peripheral surface 9a of the seal portion 9 is formed into a shape of a cylindrical surface. Between the inner peripheral surface 9a of the seal portion 9 and a tapered outer peripheral surface 2a2 of the shaft portion 2a, there is formed a wedge-like seal space S gradually reduced downward in radial dimension. The seal space S constitutes a capillary seal for retaining a lubricating oil with a capillary force of the seal space S. Within a range of operational temperature of the bearing device, the volume of the seal space S is set to be larger than a thermal expansion amount of the lubricating oil retained in the bearing device. With this, within the range of the operational temperature of the bearing device, the lubricating oil does not leak from the seal space S, and an oil level thereof is constantly maintained in the seal space S.

When the shaft member 2 is rotated, a radial bearing gap is formed between the inner peripheral surface 1a of the bearing sleeve 1 and a cylindrical outer peripheral surface 2a1 of the shaft member 2, and thrust bearing gaps are formed between the lower end surface 1c of the bearing sleeve 1 and an upper end surface 2b1 of the flange portion 2b of the shaft member 2 and between the inner bottom surface 7b1 of the housing 7 and a lower end surface 2b2 of the flange portion 2b of the shaft portion. Then, when the dynamic pressure grooves 1a1 and 1a2 of the inner peripheral surface 1a of the bearing sleeve 1 generate a dynamic pressure effect in the lubricating oil in the radial bearing gap, radial bearing portions R1 and R2 are constituted which rotatably support the shaft portion 2a of the shaft member 2 in a radial direction in a non-contact manner. Simultaneously, when the dynamic pressure grooves 1c1 of the lower end surface 1c of the bearing sleeve 1 and the dynamic pressure grooves of the inner bottom surface 7b1 of the housing 7 generate a dynamic pressure effect in the lubricating oil in the thrust bearing gaps, a first thrust bearing portion T1 and a second thrust bearing portion T2 are constituted which rotatably support the flange portion 2b of the shaft member 2 in both thrust directions in a non-contact manner. In this case, a lower end of the radial bearing gap is continuous with a radially outer end of the first thrust bearing portion T1.

As described above, the dynamic pressure grooves 1a1 of the inner peripheral surface 1a of the bearing sleeve 1 are formed asymmetrically with respect to the belt-like portion of the hill portion, and the axial dimension X1 of the upper region with respect to the belt-like portion is larger than the axial dimension X2 of the lower region (refer to FIG. 1(a)). Thus, when the shaft member 2 is rotated, the lubricating-oil drawing force (pumping force) in the upper region, which is exerted by the dynamic pressure grooves 1a1, is relatively larger than that in the lower region. Owing to the differential pressure of the drawing-in force, the lubricating oil in the radial bearing gap flows downward, circulates in the route constituted by the following: the thrust bearing gap of the first thrust bearing portion T1; the axial grooves 1d1; and a space between a lower end surface 9b of the seal portion 9 and an upper end surface 1b of the bearing sleeve 1, and is re-drawn into the radial bearing gap. With the above-mentioned structure in which the lubricating oil flows and circulates in the inner space of the housing 7, it is possible to prevent a phenomenon in which pressure of the lubricating oil in the inner space becomes locally negative, and possible to solve the problems such as generation of air bubbles involved in the generation of the negative pressure, and leakage of the lubricating oil and occurrence of vibration due to the generation of air bubbles. Further, even when air bubbles are mixed into the lubricating oil for some reason or other, the air bubbles are discharged into the atmosphere through the oil surfaces (gas/liquid interfaces) of the lubricating oil in the seal space S when the air bubbles circulate with the lubricant oil. Thus, adverse effects of the air bubbles are prevented even more effectively.

While in the above-mentioned embodiment, the herringbone dynamic pressure grooves 1a1 and 1a2 are formed as the radial dynamic pressure generating portions, this should not be construed restrictively. For example, spiral dynamic pressure grooves, a step bearing, or a multi-arc bearing may be adopted. Alternatively, without the dynamic pressure generating portions, a so-called cylindrical bearing may be structured in which the outer peripheral surface 2a1 of the shaft portion 2a and the inner peripheral surface 1a of the bearing sleeve 1 form cylindrical surfaces.

Further, while in the above-mentioned embodiment, the spiral dynamic pressure grooves are formed as the thrust dynamic pressure generating portion, this should not be construed restrictively. For example, herringbone dynamic pressure grooves, a step bearing, or a corrugated bearing (with a corrugated step form) may be adopted.

Still further, in the above-mentioned embodiment, the dynamic pressure generating portions are formed in the inner peripheral surface 1a and the lower end surface 1c of the bearing sleeve 1, and in the inner bottom surface 7b1 of the housing. However, the dynamic pressure generating portions may be provided in the surfaces respectively opposed thereto through an intermediation of the bearing gaps, that is, in the outer peripheral surface 2a1 of the shaft portion 2a, and the upper end surface 2b1 and the lower end surface 2b2 of the flange portion 2b.

Yet further, while in the above-mentioned embodiment, being provided separately from each other in the axial direction, the radial bearing portions R1 and R2 may be provided continuously with each other in the axial direction. Alternatively, only any one of the radial bearing portions R1 and R2 may be provided.

Yet further, in the above-mentioned embodiments, a lubricating oil is exemplified as the fluid filling the interior of the fluid dynamic bearing device 100 and generating a dynamic pressure effect in the radial bearing gap and the thrust bearing gaps. Instead, it is also possible to use some other fluid capable of generating a dynamic pressure effect in the bearing gaps, for example, gas such as air, a magnetic fluid, or a lubricating grease.

Yet further, the above-mentioned fluid dynamic bearing device can be suitably used not only in a spindle motor of a disk drive such as an HDD, but also in the following: a small motor for an information apparatus, which is used under high-speed rotation, such as a spindle motor for driving a magneto-optical disk; a polygon scanner motor for a laser beam printer; a fan motor for an electronic apparatus; and the like.

### BRIEF DESCRIPTION OF THE DRAWINGS

FIG. 1a is a sectional view of a bearing sleeve.

FIG. 1b is a bottom view of the bearing sleeve.

FIG. 2 is a sectional view of a particle of separated alloy powder.

FIG. 3 is an enlarged sectional view of a bearing surface of the bearing sleeve.

FIG. 4 is a sectional view of another example of particles of separated alloy powder.

FIG. 5 is a sectional view of a motor incorporating a fluid dynamic bearing device.

FIG. 6 is a sectional view of the fluid dynamic bearing device provided with the bearing sleeve.

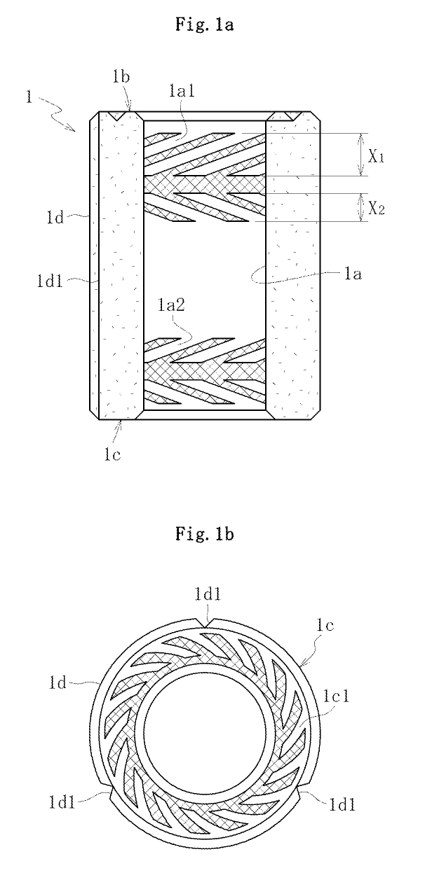

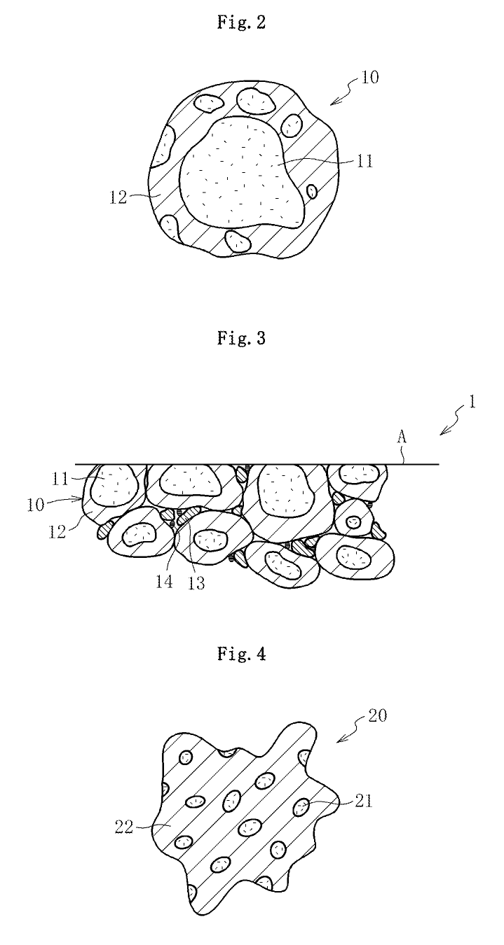

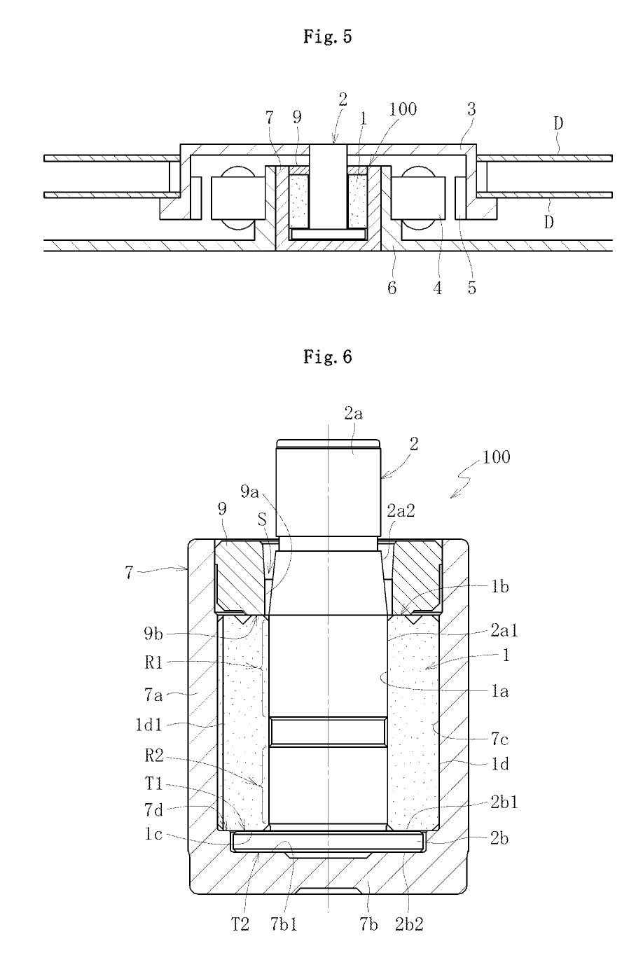

### DESCRIPTION OF SYMBOLS

1 bearing sleeve (sintered bearing)
10 separated alloy powder
11 first region (SUS steel)
12 second region (Cu-based metal)
A bearing surface
A shaft member
3 disk hub
4 stator coil
5 rotor magnet
6 bracket
7 housing
9 seal portion
100 fluid dynamic bearing device
R1, R2 radial bearing portion
T1, T2 thrust bearing portion
S seal space

1. A sintered bearing obtained by sintering a compression-molded body of metal powder, wherein the metal powder containing separated alloy powder is used, in which the separated alloy powder contains particles each having multiple regions made of different metals, and the separated alloy powder having a boundary surface between the regions is at least partially alloyed.

2. A sintered bearing according to claim 1, wherein the separated alloy powder comprises a region formed of a Fe-based metal.

3. A sintered bearing according to claim 2, wherein the Fe-based metal comprises a SUS steel.

4. A sintered bearing according to claim 2 or 3, wherein the separated alloy powder is made of the Fe-based metal whose surface is at least partially covered with another metal.

5. A sintered bearing according to claim 1, wherein the separated alloy powder comprises a region formed of a Cu-based metal.

6. A sintered bearing according to claim 1, wherein the separated alloy powder is produced by atomizing.

7. A sintered bearing according to claim 1, which is used as a fluid dynamic bearing device and comprises a bearing surface in which a dynamic pressure generating portion for generating a dynamic pressure effect in a fluid is formed.

8. A fluid dynamic bearing device, comprising:
a sintered bearing according to claim 1; and
a shaft member inserted along an inner periphery of the sintered bearing.
